(19) United States
(12) Patent Application Publication
(10) Pub. No.: US 2025/0272120 A1
(43) Pub. Date: Aug. 28, 2025

(54) ELECTRONIC DEVICE FOR CONTROLLING EXTERNAL DEVICE ON MULTI-VIEW SCREEN, AND CONTROL METHOD THEREFOR

(71) Applicant: Samsung Electronics Co., Ltd., Suwon-si (KR)

(72) Inventors: Jibum MOON, Suwon-si (KR); Haeree NA, Suwon-si (KR); Eunjin LEE, Suwon-si (KR)

(21) Appl. No.: 19/207,112

(22) Filed: May 13, 2025

Related U.S. Application Data
(63) Continuation of application No. PCT/KR2023/014401, filed on Sep. 21, 2023.

(30) Foreign Application Priority Data
Nov. 18, 2022 (KR) 10-2022-0155539

(51) Int. Cl. G06F 9/451; G06F 3/01; G06F 3/14

(52) U.S. Cl. CPC G06F 9/451; G06F 3/017; G06F 3/14

(57) ABSTRACT

An electronic device may include a display, a memory for storing at least one instruction, and at least one processor connected to the memory so as to control the electronic device, wherein the at least one processor executes the at least one instruction so as to: control the display such that a first application screen, which may include a first UI to which information related to a device is hyperlinked, is displayed; identify whether the information related to the device corresponds to a second application if the first UI is selected; identify whether the device is registered to an account of a user logged-in to the second application, if the information related to the device corresponds to the second application; control the display such that if the device is registered to the account of the user, the first application screen is displayed in a first area of the display, and a second application screen, which may include a second UI for controlling the device, is displayed in a second area of the display; and transmit the information related to the device to the device if the second UI is selected.

### CROSS-REFERENCE TO RELATED APPLICATIONS

This application is a continuation application of International Application No. PCT/KR2023/014401 designating the United States, filed on Sep. 21, 2023, in the Korean Intellectual Property Receiving Office and claiming priority to Korean Patent Application No. 10-2022-0155539, filed on Nov. 18, 2022, the disclosures of which are all hereby incorporated by reference herein in their entireties.

### BACKGROUND

### Technical Field

Certain example embodiments may relate to an electronic device and/or a control method therefor, and for example, to an electronic device for controlling an external device on a multi-view screen, and/or a control method therefor.

### Background Art

A display device (e.g., television (TV) or monitor) may provide a multi-view function for splitting a screen to display multiple screens.

Here, the display device may selectively display an application displayed on the multi-view screen based on a user input.

However, the display device does not provide a function for executing an application that controls a device registered to a user account in conjunction with a hyperlink included in the displayed screen, or to update information on the device by using the executed application.

### SUMMARY

According to an example embodiment, provided may be an electronic device that may include: a display; a memory for storing at least one instruction; and at least one processor, comprising processing circuitry, connected directly or indirectly to the memory and configured to control the electronic device, wherein the at least one processor may be individually and/or collectively configured to execute the at least one instruction to control the display to display a first application screen including a first user interface (UI) hyperlinked to information related to a device, identify whether the information related to the device corresponds to a second application if the first UI is selected, identify whether the device is registered to a user account logged into the second application if the information related to the device corresponds to the second application, control the display to display the first application screen in a first area of the display and a second application screen including a second UI for controlling the device in a second area of the display if the device is registered to the user account, and transmit the information related to the device to the device if the second UI is selected.

According to an example embodiment, provided is a control method for an electronic device including a display, the method may include: controlling the display to display a first application screen including a first user interface (UI) hyperlinked to information related to a device; identifying whether the information related to the device corresponds to a second application if the first UI is selected; identifying whether the device is registered to a user account logged into the second application if the information related to the device corresponds to the second application; displaying the first application screen in a first area of the display if the device is registered to the user account; controlling the display to display a second application screen including a second UI for controlling the device in a second area of the display; and transmitting the information related to the device to the device if the second UI is selected.

According to an example embodiment, provided is a non-transitory computer-readable recording medium including a program for executing a control method for an electronic method including a display, wherein the method may include controlling the display to display a first application screen including a first user interface (UI) hyperlinked to information related to a device, identifying whether the information related to the device corresponds to a second application if the first UI is selected, identifying whether the device is registered to a user account logged into the second application if the information related to the device corresponds to the second application, displaying the first application screen in a first area of the display if the device is registered to the user account, controlling the display to display a second application screen including a second UI for controlling the device in a second area of the display, and transmitting the information related to the device to the device if the second UI is selected.

### BRIEF DESCRIPTION OF DRAWINGS

FIG. 1 is a block diagram for describing a configuration of an electronic device according to an example embodiment.

FIG. 2 is a flowchart for describing an operation of the electronic device according to an example embodiment.

FIG. 3 is a diagram for describing a method of the electronic device for displaying a first application screen according to an example embodiment.

FIG. 4 is a diagram for describing a method of the electronic device for displaying a first application screen according to an example embodiment.

FIG. 5 is a diagram for describing a method of the electronic device for displaying information that no registered device is present according to an example embodiment.

FIG. 6 is a diagram for describing a method of the electronic device for displaying a second application screen according to an example embodiment.

FIG. 7 is a diagram for describing a method of the electronic device for displaying a second application screen according to an example embodiment.

FIG. 8 is a diagram for describing a method of the electronic device for displaying the plurality of second application screens according to an example embodiment.

FIG. 9 is a diagram for describing a method of the electronic device for displaying the plurality of second application screens according to an example embodiment.

FIG. 10 is a flowchart for describing a control method for an electronic device according to an example embodiment.

### DETAILED DESCRIPTION

The disclosure may be variously modified and have several embodiments, and specific embodiments of the disclosure are thus shown in the drawings and described in detail in the detailed description. However, it should be understood that the scope of the disclosure is not limited to the specific embodiments, and includes various modifications, equivalents and/or alternatives according to the embodiments of the disclosure. Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiments may be modified in several different forms, and the scope and spirit of the present disclosure are not limited to the following embodiments. Rather, these embodiments make the disclosure thorough and complete, and are provided to completely convey the spirit of the disclosure to those skilled in the art.

Terms used in the disclosure are used only to describe the specific embodiments rather than limit the scope of the disclosure. A term of a singular number may include its plural number unless explicitly indicated otherwise in the context.

In the disclosure, the expression “have”, “may have”, “include”, “may include” or the like, indicates the presence of a corresponding feature (for example, a numerical value, a function, an operation, or a component such as a part), and does not exclude the presence of an additional feature.

In the present disclosure, the expression “A or B”, “least one of A and/or B” or “one or more of A and/or B” or the like may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions “first”, “second”, and the like used in the present disclosure may indicate various components regardless of the sequence and/or importance of the components. These expressions are only used to distinguish one component and another component from each other, and do not limit the corresponding components.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

On the other hand, if any component (for example, the first component) is mentioned to be “directly coupled with/to” or “directly connected to” another component (for example, the second component), it should be understood that yet another component(s) (for example, the third component) is not present between any component and another component. Thus, for example, “connected” as used herein covers both direct and indirect connections.

An expression “configured (or set) to” used in the present disclosure may be replaced by an expression “suitable for”, “having the capacity to”, “designed to”, “adapted to”, “made to” or “capable of” based on a context. The expression “configured (or set) to” may not necessarily indicate “specifically designed to” in hardware. “Based on” as used herein covers based at least on.

Instead, an expression a “device configured to” in any context may indicate that the device may “perform˜” together with another device or component. For example, a “processor configured (or set) to perform A, B, and C” may indicate a dedicated processor (for example, an embedded processor) that may perform the corresponding operations or a generic-purpose processor (for example, a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware. Thus, each “module” herein may comprise circuitry.

Meanwhile, the various elements and areas in the drawings are schematically shown. Therefore, the spirit of the disclosure is not limited by relative sizes or intervals shown in the accompanying drawings.

Hereinafter, the embodiments of the disclosure are described in detail with reference to the accompanying drawings so that those skilled in the art to which the disclosure pertains may easily practice the disclosure.

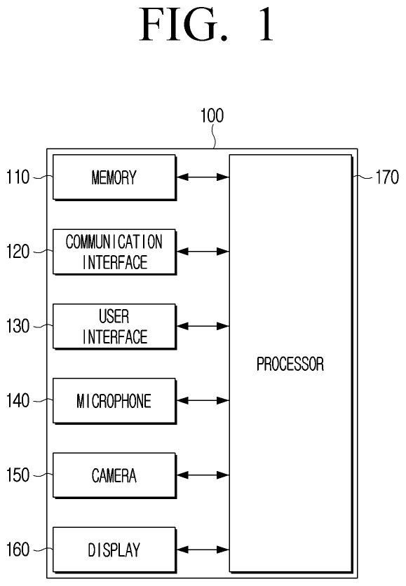

FIG. 1 is a block diagram for describing a configuration of an electronic device according to an example embodiment.

An electronic device 100 may include a memory 110, a communication interface 120, a user interface 130, a microphone 140, a camera 150, a display 160, and a processor 170. The electronic device 100 may omit some of the above components, and may further include other components.

In addition, the electronic device 100 may be implemented as a smart television (TV), which is only an embodiment, and may be implemented in any of various forms such as a TV, a smartphone, a set-top box, a mobile phone, a server, a personal digital assistant (PDA), a laptop, a media player, an e-book reader, a digital broadcasting terminal, a navigation device, a kiosk, an MP3 player, a wearable device, a home appliance, or another mobile or non-mobile computing device.

The memory 110 may store at least one instruction regarding the electronic device 100. The memory 110 may store an operating system (O/S) for operating the electronic device 100. In addition, the memory 110 may store various software programs or applications for operating the electronic device 100 according to various embodiments of the present disclosure. In addition, the memory 110 may include a semiconductor memory such as a flash memory, or a magnetic storing medium such as a hard disk.

In detail, the memory 110 may store various software modules for performing the operation of the electronic device 100 according to the various embodiments of the present disclosure, and the processor 170 may control the operation of the electronic device 100 by executing the various software modules stored in the memory 110. That is, the memory 110 may be accessed by the processor 170, and the processor 170 may perform readout, recording, correction, deletion, update and the like of data in the memory 110.

Meanwhile, in the present disclosure, the term “memory 110” may be used as a concept including the memory 110, a read only memory (ROM, not shown), a random access memory (RAM, not shown) included in the processor 170, or a memory card (not shown) (e.g., micro secure digital (SD) card or a memory stick) mounted in the electronic device 100.

In addition, the communication interface 120 is a component that includes circuitry and may communicate with an external device or a server. The communication interface 120 may communicate with the external device or the server based on a wired or wireless communication method. The communication interface 120 may include a Bluetooth module (not shown), a wireless fidelity (Wi-Fi) module (not shown), an infrared (IR) module, a local area network (LAN) module, an Ethernet module, or the like. Here, each communication module may be implemented in the form of at least one hardware chip. In addition to the above-described communication methods, a wireless communication module may include at least one communication chip for performing the communication based on various wireless communication standards such as ZigBee, universal serial bus (USB), mobile industry processor interface camera serial interface (MIPI CSI), 3rd generation (3G), 3rd generation partnership project (3GPP), long term evolution (LTE), LTE advanced (LTE-A), 4th generation (4G), and 5th generation (5G). However, this configuration is only an embodiment, and the communication interface 120 may use at least one communication module among various communication modules comprising communication circuitry.

The user interface 130 is a component for receiving a user command to control the electronic device 100. The user interface 130 may be implemented as a device such as a button, a touch pad, a mouse, or a keyboard, or may also be implemented as a touchscreen capable of performing both display and manipulation input functions. Here, the button may be any of various types of buttons, such as a mechanical button, a touch pad, or a wheel, which is positioned in any area, such as a front surface portion, side surface portion, or rear surface portion of a body appearance of the electronic device 100. The electronic device 100 may acquire various user inputs through the user interface 130.

The microphone 170 may be a component for receiving a user voice or other sounds and convert the user voice or other sounds into audio data. The microphone 140 may receive the user voice while being activated. For example, the microphone 140 may be formed integrally with the electronic device 100 in its upper, front, or side direction. The microphone 140 may include various components such as the microphone for collecting the user voice in an analog form, an amplifier circuit for amplifying the collected user voice, an analog-to-digital (A/D) conversion circuit for sampling the amplified user voice and converts/converting the same into a digital signal, and a filter circuit for removing a noise component from the converted digital signal.

The camera 150 may capture an image and a video. According to the various embodiments, a camera module may include one or more lenses, an image sensor, an image signal processor, or a flash.

The display 160 may be implemented as any of various types of displays such as a liquid crystal display (LCD), an organic light emitting diode (OLED) display, a plasma display panel (PDP). The display 160 may also include a driving circuit, a backlight unit, and the like, which may be implemented in a form such as an amorphous silicon thin film transistor (a-si TFT), a low temperature poly silicon (LTPS) TFT, or an organic TFT (OTFT). Meanwhile, the display 160 may be implemented as a touchscreen combined with a touch sensor, a flexible display, a three-dimensional (3D) display, or the like.

The processor 170 may control overall operations and functions of the electronic device 100. In detail, the processor 170 may be connected to the configuration of the electronic device 100 including the memory 110, and may control the overall operations of the electronic device 100 by executing at least one instruction stored in the memory 110 as described above.

The processor 170 may be implemented in various ways. For example, the processor 170 may be implemented as at least one of an application specific integrated circuit (ASIC), a logic integrated circuit, an embedded processor, a microprocessor, a hardware control logic, a hardware finite state machine (FSM), or a digital signal processor (DSP). Meanwhile, in the present disclosure, the term “processor” may be used as a concept including a central processing unit (CPU), a graphic processing unit (GPU), a main processing unit (MPU), or the like.

The operation of the processor 170 for implementing the various embodiments according to the present disclosure may be implemented using a plurality of modules.

In detail, data on the plurality of modules according to the present disclosure may be stored in the memory 110, and the processor 170 may access the memory 110 to load the data on the plurality of modules into an internal memory or buffer included in the processor 170, and then use the plurality of modules to implement the various embodiments according to the present disclosure.

However, at least one of the plurality of modules according to the present disclosure may be implemented in hardware and included in the processor 170 in the form of a system on chip.

Alternatively, at least one of the plurality of modules according to the present disclosure may be implemented as a separate external device, and the electronic device 100 and each module may perform the communication and perform the operation according to the present disclosure.

Hereinafter, the operation of the processor 170 according to the present disclosure may be described in detail with reference to the accompanying drawings.

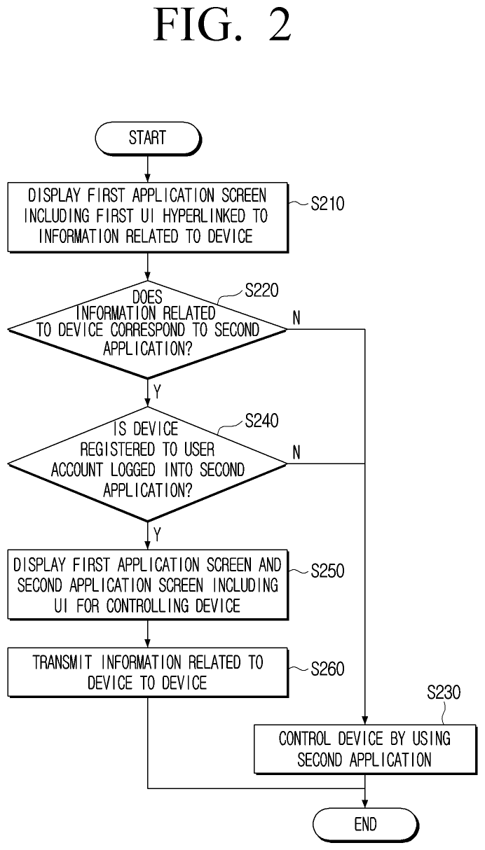

Referring to FIG. 2, the processor 170 may control the display 160 to display a first application screen including a first user interface (UI) hyperlinked to information related to a device (S210).

Here, the device may indicate the home appliance, which is only an embodiment, and may be implemented as any of various types of devices such as internet of things (IoT) devices.

In addition, the information related to the device may be information for updating the device. For example, the information related to the device may be information for updating device firmware.

Alternatively, the information related to the device may be information for updating information included in the device. For example, if the device is a cooking appliance, the information related to the device may be recipe information for updating recipe information of the cooking appliance.

In addition, a first application may be a web browser application, and the first application screen may indicate a web page screen provided by the web browser application.

In addition, the first UI included in the first application screen may be a UI hyperlinked to a network path for access to an external server that may acquire the information related to the device. Here, if the first UI is selected, the processor 170 may acquire the information related to the device from the external server.

Meanwhile, the first UI may be a UI included in a web page, which is only an embodiment, and the processor 170 may also control the display 160 to display the first UI on the web page.

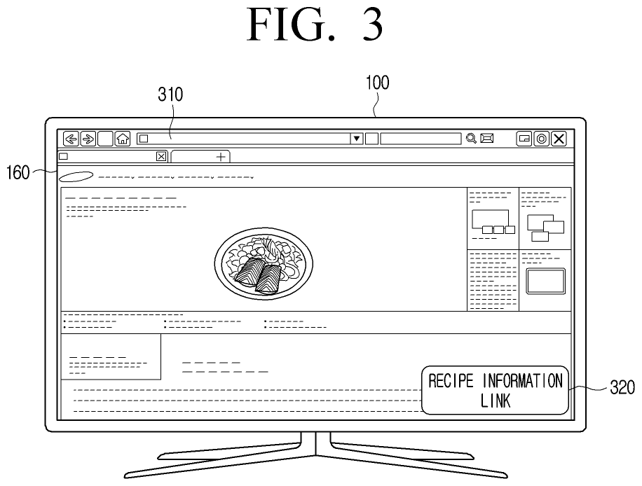

Referring to FIG. 3, the processor 170 may control the display 160 to display a web page including the recipe information by using the web browser application. Here, the web page may include a UI 320 for transmitting the recipe information to the device.

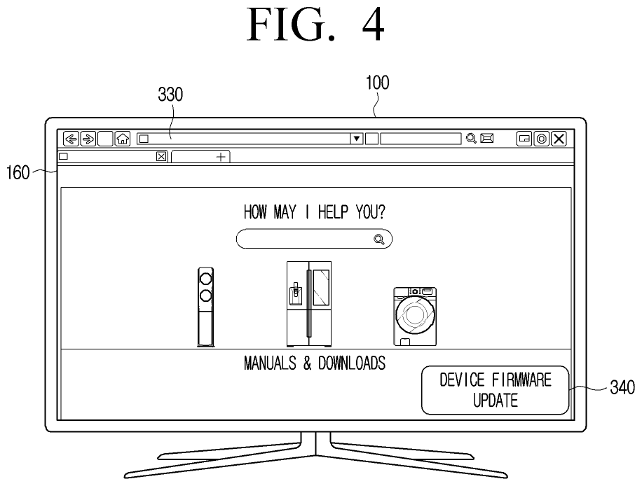

Alternatively, as shown in FIG. 4, the processor 170 may control the display 160 to display a web page 330 including the device firmware update information by using the web browser application. Here, the web page may include a UI 340 for transmitting the firmware update information to the device.

In addition, the processor 170 may identify whether the device is a device registered to a user account logged into a second application if the first UI is selected.

In detail, the processor 170 may identify whether the information related to the device that is hyperlinked to the first UI corresponds to the second application if the first UI is selected (S220).

In detail, the processor 170 may identify whether the information related to the device includes identification information for the second application. Here, the processor 170 may identify the information related to the device as corresponding to the second application if the information related to the device includes the identification information for the second application.

Here, the second application may be an application pre-installed on the electronic device 100. In addition, the second application may be an application for controlling the device registered to the user account logged into the second application.

Here, the processor 170 may control the display to continuously display the first application screen (S230) if the information related to the device does not correspond to the second application (S220-N).

In addition, the processor 170 may identify whether the device is registered to the user account logged into the second application (S240) if the information related to the device corresponds to the second application (S220-Y).

The processor 170 may control the display 160 to continuously display the first application screen (S230) if the device is not registered to the user account (S240-N).

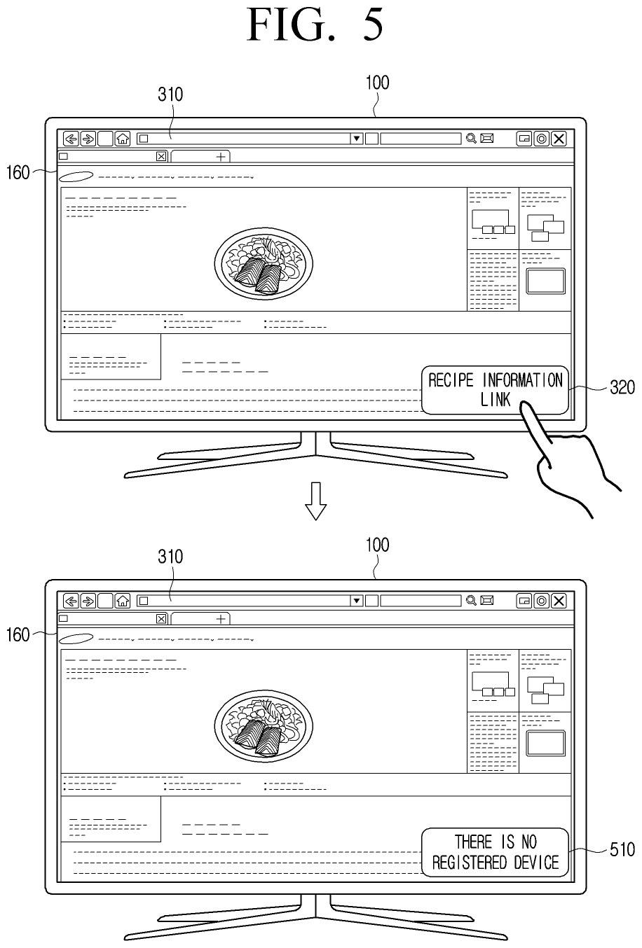

Here, the processor 170 may control the display 160 to display information indicating that the device is not registered to the user account if the device is not registered to the user account. For example, as shown in FIG. 5, the processor 170 may control the display 160 to display information 510 such as “There is no registered device”, if the first UI 320 is selected and the device is not registered to the user account.

Here, the displayed information may be displayed on the first application screen 310, which is only an embodiment, and the displayed information may be displayed in various forms.

In addition, the processor 170 may control the display 160 to display the first application screen in a first area of the display 160 and a second application screen including a second UI for controlling the device in a second area of the display 160 (S250) if the device is registered to the user account (S240-Y).

Here, the processor 170 may display the first application screen and the second application screen together. That is, the processor 170 may control the display 160 to display a multi-view screen including the first application screen and the second application screen.

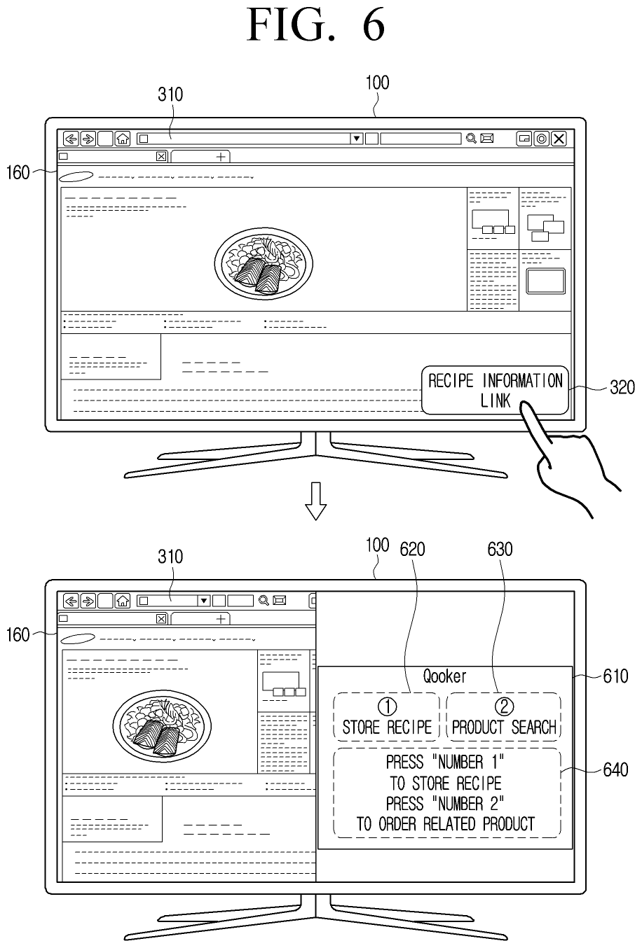

For example, as shown in FIG. 6, the processor 170 may control the display 160 to display the first application screen 310 including the recipe information in the first area of the display 160 if the first UI 320 for storing the recipe information in the device is selected while the first application screen 310 including the recipe information is displayed, and control the display 160 to display a second application screen 610 including a UI 620 for storing the recipe information in the device in the second area of the display 160. Here, the second application screen 610 may also include a UI 630 for searching for a product (or an ingredient) included in the recipe information.

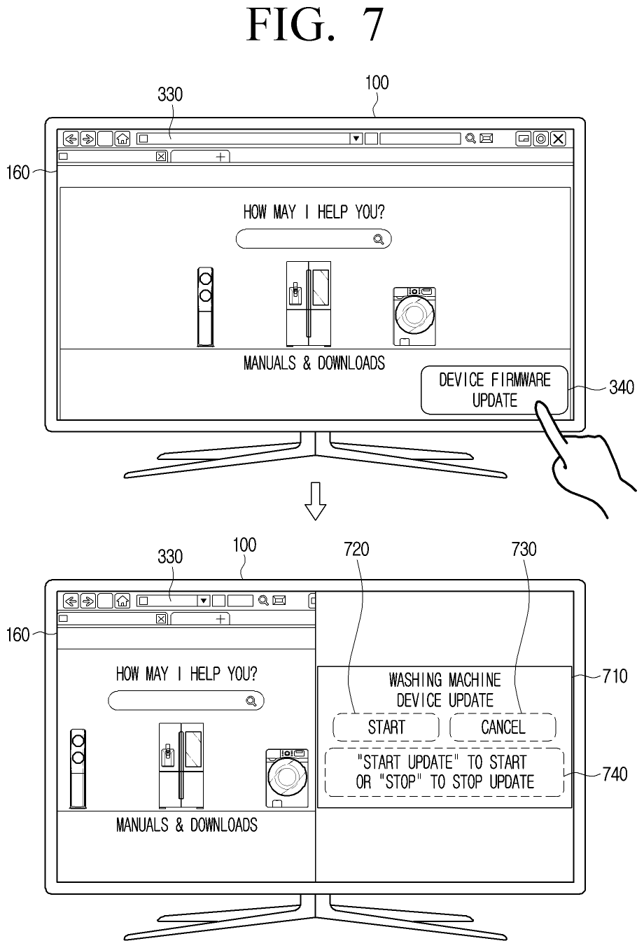

Alternatively, as shown in FIG. 7, the processor 170 may display the first application screen 330 including the device firmware update information in the first area of the display 160, and display a second application screen 710 including a UI 720 for starting device firmware update if the UI 340 for updating the device firmware is selected while the first application screen 330 including the device firmware update information is displayed. Here, the second application screen 710 may also display a UI 730 for canceling the device firmware update. In addition, the second application screen 710 may also display information 740 for describing an UI being displayed.

Meanwhile, according to an example embodiment, the information related to the device may indicate the plurality of information related to a device. In addition, the plurality of devices (e.g., first device and second device) may be registered to the user account logged into the second application. Here, the processor 170 may display the first application screen in the first area of the display 160, display the second application screen including the UI for controlling the first device in the second area of the display 160, and display a third application screen including a UI for controlling the second device in a third area of the display 160 if the first UI is selected while the first application screen is displayed.

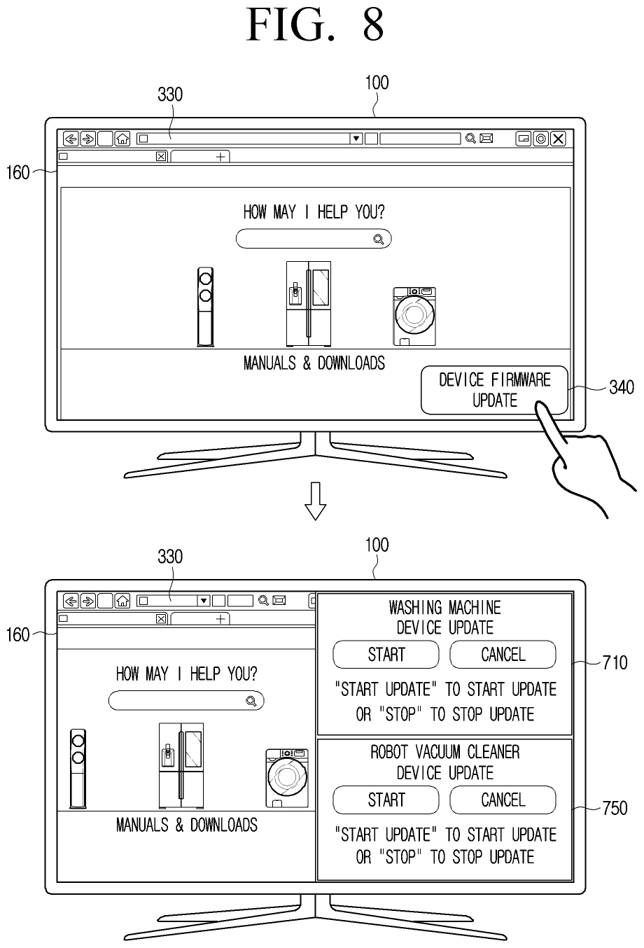

For example, the device firmware update information may include the firmware update information for each of the plurality of devices. In addition, the plurality of devices may be registered to the user account logged into the second application. Here, as shown in FIG. 8, the processor 170 may display the first application screen 330 including the device firmware update information in the first area of the display 160, display the second application screen 710 including a UI for updating the firmware of the first device (e.g., washing machine) in the second area of the display 160, and display a second application screen 750 including a UI for updating the firmware of the second device (e.g., robot vacuum cleaner) in the third area of the display 160 if the UI 340 for updating the device firmware is selected while the first application screen 330 including the device firmware update information is displayed.

In addition, the processor 170 may transmit the information related to the device to the device if a user input for controlling the device is acquired while the second application screen is displayed (S260). Here, the processor 170 may update the device (or the information included in the device) by transmitting the information related to the device to the device.

Here, the user input for controlling the device may be a user input for selecting the UI included in the second application screen.

Here, the user input for selecting the UI may be a user input for selecting the UI through the user interface 130, which is only an embodiment, and may be a user voice input or a user gesture input for selecting the UI.

According to an example embodiment, the processor 170 may transmit the information related to the device to the device if a user voice signal that utters a predetermined text through the microphone 140 is acquired while the second application screen is displayed.

Here, the second application screen may display information on the predetermined text together. For example, referring to FIG. 6, the second application screen 610 may include information 640 on the predetermined text for selecting the UI 620 or 630 included in the second application screen 610, such as “Press “number 1” to store a recipe,” or “Press “number 2” to order a related product.” Here, the processor 170 may perform an operation corresponding to the predetermined text if the user voice signal that utters the predetermined text (“number 1” or “number 2”) is acquired. That is, the processor 170 may control the device to transmit the recipe information to the device and store a recipe if the user voice signal that utters “number 1” is acquired. In addition, the processor 170 may order the related product included in the recipe if the user voice signal that utters “number 2” is acquired.

Alternatively, referring to FIG. 7, the second application screen 710 may include information on the predetermined text 740 for selecting the UI 720 or 730 included in the second application screen 710, such as ““Start update” to start the update” or ““Stop” to stop the update.” Here, the processor 170 may perform an operation corresponding to the predetermined text if the user voice signal that utters the predetermined text “Start update” or “Stop”) is acquired. That is, the processor 170 may transmit the update information to the device to start the device update if the user voice signal that utters “Start update” is acquired. In addition, the processor 170 may stop the device update if the user voice signal that utters “Stop” is acquired. Here, as shown in FIG. 4, the processor 170 may control the display 160 to display the first application screen by excluding the second application screen if the device update is stopped.

Meanwhile, according to an example embodiment, the processor 170 may transmit the information related to the device to the device if a user gesture identical to a predetermined gesture is recognized using the camera 150 while the second application screen is displayed.

For example, the processor 170 may perform an operation corresponding to a pointed UI if a gesture in which a user points at the UI included in the second application screen by using a finger is recognized. Here, the processor 170 may update the device by transmitting the information related to the device to the device.

Meanwhile, according to an example embodiment, the processor 170 may control the display 160 to display the first application screen including a UI hyperlinked to information related to the second device while the second application screen for controlling the first device is displayed.

In addition, the processor 170 may display the first application screen in the first area of the display 160, display the second application screen for controlling the first device in the second area of the display 160, and display the second application screen for controlling the second device in the third area of the display 160 if the UI hyperlinked to the information related to the second device is selected.

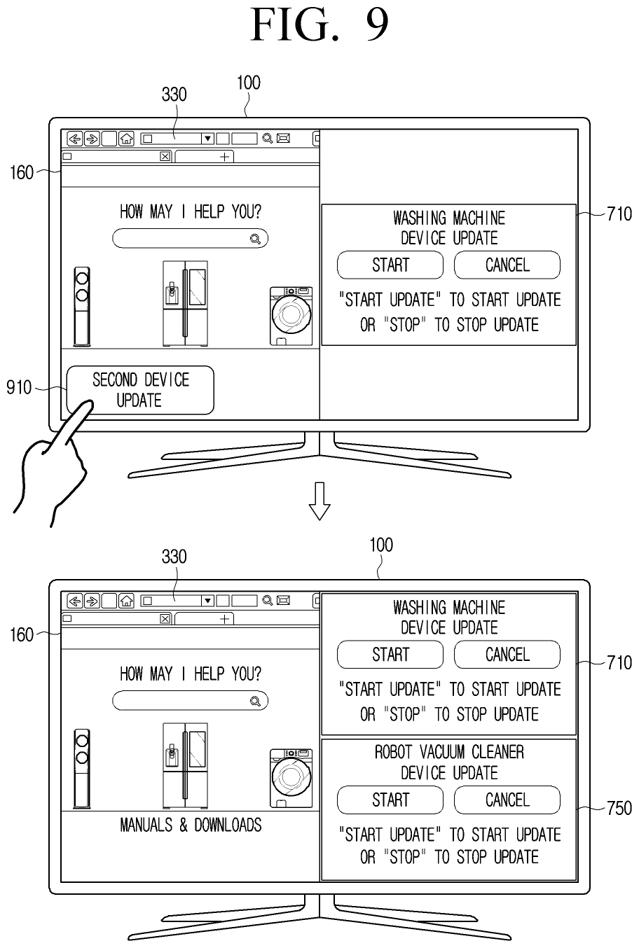

For example, as shown in FIG. 9, the processor 170 may display the first application screen 330 including a UI 910 hyperlinked to the information related to the second device while the second application screen 710 for controlling the device is displayed.

Here, the processor 170 may control the display 160 to display the first application screen 330 in the first area of the display 160, display the second application screen 710 for controlling the device in the second area of the display 160, and display the second application screen 750 for controlling the second device in the third area of the display 160 if the UI 910 hyperlinked to the information related to the second device is selected.

Meanwhile, the processor 170 may transmit information related to the first device to the first device and transmit the information related to the second device to the second device if the user input for transmitting the information related to the device to the device and transmitting the information related to the second device to the second device is acquired while the second application screen for controlling the first device and the second application screen for controlling the second device are displayed together. For example, in this case, the user input may be a user voice input such as “Update all.”

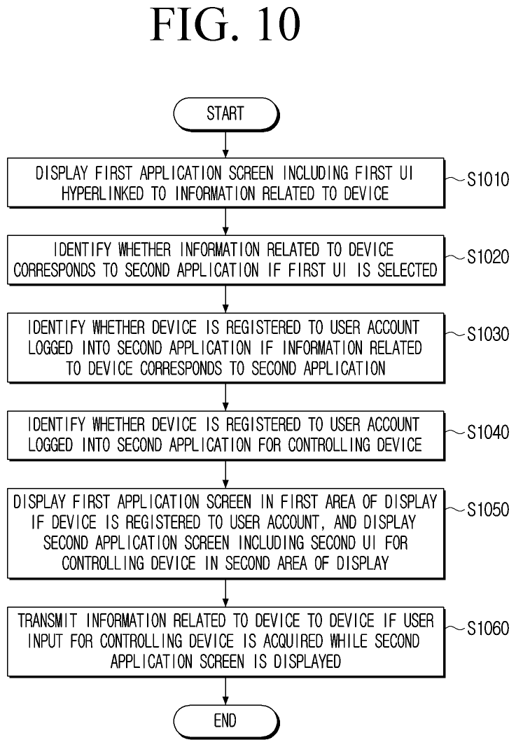

FIG. 10 is a flowchart for describing a control method for an electronic device 100 according to an example embodiment.

The electronic device 100 may control the display 160 to display the first application screen including the first UI hyperlinked to the information related to the device (S1010).

In addition, the electronic device 100 may identify whether the information related to the device corresponds to the second application if the first UI is selected (S1020). In detail, the electronic device 100 may identify whether the information related to the device includes the identification information for the second application if the first UI is selected, and identify the information related to the second device as corresponding to the second application if the information related to the device includes the identification information for the second application.

Here, the second application may be the application for controlling the device registered to the user account logged into the second application.

In addition, the electronic device 100 may identify whether the device is registered to the user account logged into the second application if the information related to the device corresponds to the second application (S1030).

In addition, the electronic device 100 may control the display 160 to display the first application screen in the first area of the display 160 if the device is registered to the user account, and control the display 160 to display the second application screen including the second UI for controlling the device in the second area of the display 160 (S1050).

In addition, the electronic device 100 may transmit the information related to the device to the device if the second UI is selected. Here, the electronic device 100 may update the device by transmitting the information related to the device to the device.

Meanwhile, the electronic device 100 may transmit the information related to the device to the device if the user voice signal that utters the predetermined text through the microphone is acquired while the second application screen is displayed.

Alternatively, the electronic device 100 may transmit the information related to the device to the device if the user gesture identical to the predetermined gesture is recognized using the camera while the second application screen is displayed.

Meanwhile, the electronic device 100 may update the device firmware if the information related to the device is the information for updating the device firmware and the second UI is selected.

Meanwhile, the electronic device 100 may control the display 160 to display the first application screen including a third UI hyperlinked to the information related to the second device in the first area of the display 160 while the second application screen is displayed in the second area of the display 160. Here, the electronic device 100 may identify whether the second device is registered to the user account if the third UI is selected. In detail, the electronic device 100 may identify whether the information related to the second device corresponds to the second application if the third UI is selected. In addition, the electronic device 100 may identify whether the second device is registered to the user account logged into the second application if the information related to the second device corresponds to the second application.

In addition, the electronic device 100 may control the display 160 to display the second application screen including a fourth UI for controlling the second device in the third area of the display 160 if the second device is registered to the user account.

Here, the electronic device 100 may transmit the information related to the device to the device and transmit the information related to the second device to the second device if the user input for transmitting the information related to the device to the device and transmitting the information related to the second device to the second device is acquired.

Meanwhile, the device may be the cooking appliance. In addition, the information related to the device may be the recipe information for cooking a dish displayed on the first application screen. Here, the electronic device 100 may transmit the recipe information to the device if the second UI is selected.

Meanwhile, the term “part” or “module” used in the disclosure may include a unit including hardware, software, or firmware, and may be used interchangeably with the term, for example, a logic, a logic block, a component, or a circuit. The “part” or “module” may be an integrally formed component or a minimum unit or part performing one or more functions. For example, the module may include an application-specific integrated circuit (ASIC). Thus, each “module” herein may comprise circuitry.

The various embodiments of the disclosure may be implemented in software including an instruction stored on a machine-readable storage medium (for example, a computer-readable storage medium). A machine may be a device that invokes the stored instruction from a storage medium, may be operated based on the invoked instruction, and may include the electronic device 100 according to the disclosed embodiments. If the instruction is executed by the processor, the processor may directly perform a function corresponding to the instruction or other components may perform the function corresponding to the instruction under the control of the processor. The instruction may include codes generated or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

According to an embodiment, the methods according to the various embodiments described in this document may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store (for example, PlayStore™. In case of the online distribution, at least a portion of the computer program product may be at least temporarily stored or temporarily generated on a storage medium such as the memory of a manufacturer server, an application store server, or a relay server.

Each of the components (for example, modules or programs) according to the various embodiments may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

1. An electronic device comprising:
a display;
a memory for storing at least one instruction; and
at least one processor, comprising processing circuitry, connected to the memory and configured to control the electronic device,
wherein the at least one processor is individually and/or collectively configured to execute the at least one instruction to:
control the display to display a first application screen including a first user interface (UI) hyperlinked to information related to a device,
based on the first UI being selected, identify whether the information related to the device corresponds to a second application,
based on the information related to the device corresponding to the second application, identify whether the device is registered to a user account logged into the second application,
based on the device being registered to the user account, control the display to display the first application screen in a first area of the display and a second application screen including a second UI for controlling the device in a second area of the display, and
based on the second UI being selected, transmit the information related to the device.

2. The device as claimed in claim 1, wherein the second application is an application for controlling a device registered to the user account logged into the second application.

3. The device as claimed in claim 1, wherein the at least one processor is individually and/or collectively configured to
based on the first UI being selected, identify whether the information related to the device includes identification information for the second application, and
based on the information related to the device including the identification information for the second application, identify information related to a second device as corresponding to the second application.

4. The device as claimed in claim 1, further comprising a microphone,
wherein the at least one processor is individually and/or collectively configured to, based on a user voice signal that utters a predetermined text being acquired through the microphone while the second application screen is displayed, transmit the information related to the device to the device.

5. The device as claimed in claim 1, further comprising a camera,
wherein the at least one processor is individually and/or collectively configured to, based on a user gesture identical to a predetermined gesture being recognized using the camera while the second application screen is displayed, transmit the information related to the device to the device.

6. The device as claimed in claim 1, wherein the at least one processor is individually and/or collectively configured to, based on the information related to the device being information for updating the device firmware and the second UI being selected, update device firmware.

7. The device as claimed in claim 1, wherein the at least one processor is individually and/or collectively configured to
control the display to display the first application screen including a third UI hyperlinked to information related to a second device in the first area of the display while the second application screen is displayed in the second area of the display,
based on the third UI being selected, identify whether the second device is registered to the user account, and
based on the second device being registered to the user account, control the display to display the second application screen including a fourth UI for controlling the second device in a third area of the display.

8. The device as claimed in claim 7, wherein the at least one processor is individually and/or collectively configured to
based on the third UI being selected, identify whether the information related to the second device corresponds to the second application, and
based on the information related to the second device corresponding to the second application, identify whether the second device is registered to the user account logged into the second application.

9. The device as claimed in claim 7, wherein the at least one processor is individually and/or collectively configured to transmit the information related to the device to the device and transmit the information related to the second device to the second device if a user input for transmitting the information related to the device to the device and transmitting the information related to the second device to the second device is acquired.

10. The device as claimed in claim 1, wherein the device is a cooking appliance,
the information related to the device is recipe information for cooking a dish displayed on the first application screen, and
the at least one processor is individually and/or collectively configured to, based on the second UI being selected, transmit the recipe information to the device.

11. A control method for an electronic device including a display, the method comprising:
controlling the display to display a first application screen including a first user interface (UI) hyperlinked to information related to a device;
based on the first UI being selected, identifying whether the information related to the device corresponds to a second application;
based on the information related to the device corresponding to the second application, identifying whether the device is registered to a user account logged into the second application;
based on the device being registered to the user account, displaying the first application screen in a first area of the display;
controlling the display to display a second application screen including a second UI for controlling the device in a second area of the display; and
based on the second UI being selected, transmitting the information related to the device to the device.

12. The method as claimed in claim 11, wherein the second application is an application for controlling a device registered to the user account logged into the second application.

13. The method as claimed in claim 11, wherein in the identifying of whether the information related to the device corresponds to the second application if the first UI is selected,
based on the first UI being selected, whether the information related to the device includes identification information for the second application is identified, and
based on the information related to the device including the identification information for the second application, information related to a second device is identified as corresponding to the second application.

14. The method as claimed in claim 11, wherein in the transmitting of the information related to the device to the device,
the device is updated by transmitting the information related to the device to the device.

15. The method as claimed in claim 11, wherein in the transmitting of the information related to the device to the device,
based on a user voice signal that utters a predetermined text being acquired through the microphone while the second application screen is displayed, the information related to the device is transmitted to the device.

16. The method as claimed in claim 11, wherein in the transmitting of the information related to the device to the device,
based on a user gesture identical to a predetermined gesture being recognized using the camera while the second application screen is displayed, the information related to the device is transmitted to the device.

17. The method as claimed in claim 11, wherein in the transmitting of the information related to the device to the device,
based on the information related to the device being information for updating the device firmware and the second UI being selected, device firmware is updated.

18. The method as claimed in claim 11, further comprising:
controlling the display to display the first application screen including a third UI hyperlinked to information related to a second device in the first area of the display while the second application screen is displayed in the second area of the display;
based on the third UI being selected, identifying whether the second device is registered to the user account; and
based on the second device being registered to the user account, controlling the display to display the second application screen including a fourth UI for controlling the second device in a third area of the display.

19. The method as claimed in claim 18, wherein in the identifying of whether the second device is registered to the user account if the third UI is selected,
based on the third UI being selected, whether the information related to the second device corresponds to the second application is identified, and
based on the information related to the second device corresponding to the second application, whether the second device is registered to the user account logged into the second application is identified.

20. A non-transitory computer-readable recording medium including a program for executing a control method for an electronic method including a display, wherein the method includes
controlling the display to display a first application screen including a first user interface (UI) hyperlinked to information related to a device,
based on the first UI being selected, identifying whether the information related to the device corresponds to a second application,
based on the information related to the device corresponding to the second application, identifying whether the device is registered to a user account logged into the second application,
based on the device being registered to the user account, displaying the first application screen in a first area of the display,
controlling the display to display a second application screen including a second UI for controlling the device in a second area of the display, and
based on the second UI being selected, transmitting the information related to the device to the device.
